(19) United States
(12) Patent Application Publication
(10) Pub. No.: US 2017/0032383 A1
(43) Pub. Date: Feb. 2, 2017

(54) Systems and Methods for Trending Abnormal Data

(71) Applicant: MASTERCARD INTERNATIONAL INCORPORATED, Purchase, NY (US)

(72) Inventors: Kenneth Unser, Fairfield, CT (US); Serge Bernard, Danbury, CT (US)

(21) Appl. No.: 14/812,390

(22) Filed: Jul. 29, 2015

(51) Int. Cl. G06Q 30/02; G06Q 40/00

(52) U.S. Cl. CPC G06Q 30/0201; G06Q 40/12

(57) ABSTRACT

Systems and methods are provided for identifying traits of abnormal data. One exemplary method includes accessing transaction data as associated with at least one merchant, where the transaction data includes multiple transactions. The exemplary method further including detecting abnormal transactions from the multiple transactions based on at least one parameter of the transactions, identifying, at a computing device, at least one trait associated with at least a portion of the abnormal transactions, but not associated with a typical consumer associated with the at least one merchant, and reporting the at least one trait to the at least one merchant.

### FIELD

The present disclosure generally relates to systems and methods for use in trending abnormal data, including abnormal transaction data, so that common traits of the abnormal data can be identified and reported.

### BACKGROUND

This section provides background information related to the present disclosure which is not necessarily prior art.

Merchants often offer products (e.g., goods and services, etc.) for sale to consumers. As an aspect of the product purchases, by the consumers, the merchants often collect data about the consumers. For example, the merchants often offer loyalty programs, which permit the merchants to track purchase activities per consumer, generally, or specifically per products purchased by the consumers. Based on the collected data, the merchants are able to provide special offers to the consumers for particular products previously purchased by the consumers, or discounts for the regular patronage of, or loyalty to, the merchants.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in trending abnormal data;

FIG. 2 is a block diagram of a computing device, that may be used in the exemplary system of FIG. 1; and

FIG. 3 is an exemplary method for use in trending abnormal data, in connection with the system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers enter into transactions with merchants to purchase products (e.g., goods or services). Generally, the products are used in a conventional manner by the consumers. But occasionally, consumers employ the products for something other than their conventional use. In these later cases, purchases of the products by the consumers often exhibit abnormal parameters or traits, as compared to purchases of the products by consumers who use the products in their conventional manner (such that that the associated abnormal transactions include transactions that deviate from the norm, are atypical, are different from the average transactions, etc.). Typically, such abnormal transactions are identified, during various analyses of transaction data, and discarded to ensure they do not skew the analyses. The systems and methods herein identify such abnormal transactions at the merchants and then, instead of discarding the transactions, further identify traits that are common among the abnormal transactions (including among the consumers making the transactions) but dissimilar from those of typical transactions at the merchants. In so doing, where patterns or commonalties among the abnormal transactions exist (e.g., are determined, etc.), potential opportunities for new market segments for the merchants may be identified. The traits, possibly along with other pertinent information, can then be reported to the merchants, who may utilize the traits to develop the new market segments.

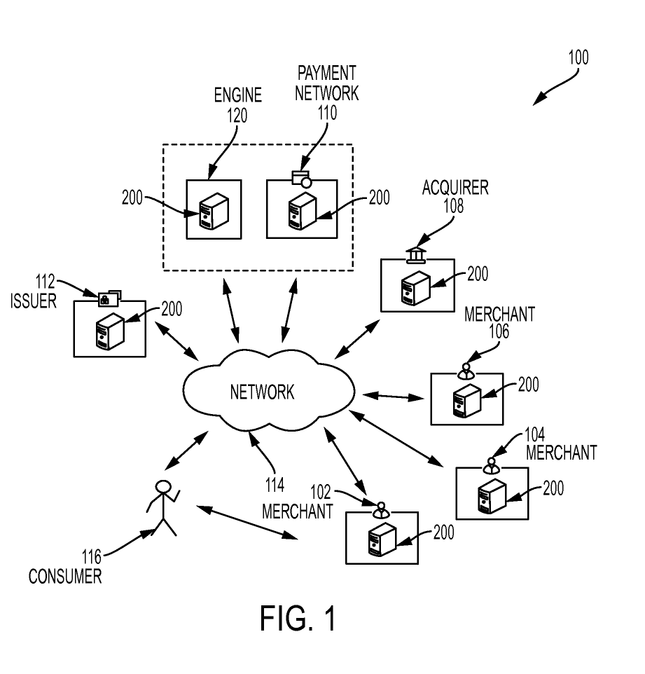

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on a manner and/or location in which transaction data is stored, interactions and/or relationships between the various components, and/or processing of payment transactions, etc.

As shown in FIG. 1, the illustrated system 100 generally includes multiple merchants 102, 104, and 106, an acquirer 108, a payment network 110, and an issuer 112, each coupled to network 114. The network 114 of the system 100 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 114 includes multiple networks, where different ones of the multiple networks are accessible to different ones of the illustrated components in FIG. 1.

The merchants 102, 104, and 106 may be any merchant, at which consumers (e.g., consumer 116) may complete transactions for products (e.g., goods or services, etc.). Often, the merchants 102, 104, and 106 specialize in particular types of products. For example, sporting goods stores offer sports equipment and apparel for sale, and hardware stores offer tools and construction material for sale, while shoe stores offer shoe products for sale. In addition, the merchants 102, 104, and 106 may be, for example, online merchants, or smaller merchants, that offer a limited selection of products for sale. For example, a sole proprietor of a garment store may offer only a dozen different garment products intended only for women or men, or a particular profession (e.g., medical garments, construction garments, etc.), while a larger merchant may offer hundreds of garment products targeting various different demographics of consumers. Broadly, different merchants of various sizes offer different types and quantities of products for sale to consumers. Commonly, however, a merchant will have a typical consumer, in general or for specific products offered for sale. For example, a typical customer at a boutique jewelry store may be a woman between 26 and 42 years of age, and a typical consumer of a laundry detergent may be a man between 21 and 78 years of age. In addition, merchants occasionally have consumers, who are inconsistent with their typical consumer, i.e., an atypical consumer. The identification of atypical consumers, and transactions to atypical consumers (e.g., abnormal transactions, etc.), is described in detail below.

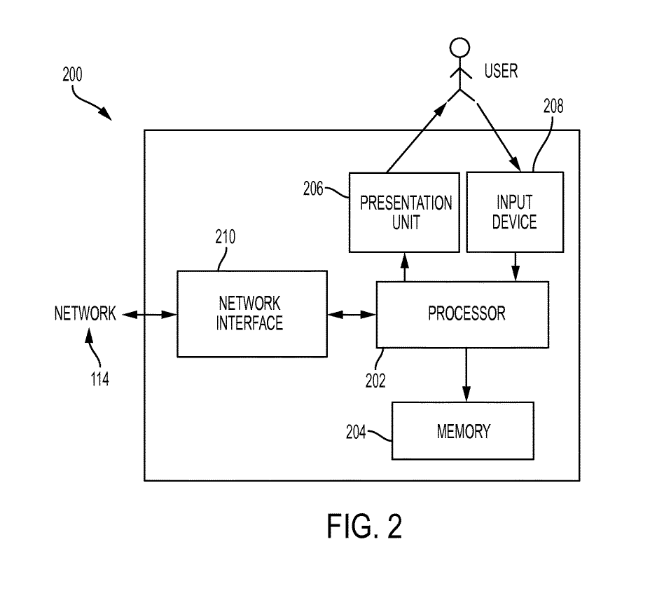

Each of the merchants 102, 104, and 106, the acquirer 108, the payment network 110, the issuer 112, and the consumer 116 in the system 100 is associated with, or implemented in, one or more computing devices. For illustration, the system 100 is described with reference to exemplary computing device 200, illustrated in FIG. 2. And, each of the merchants 102, 104, and 106, the acquirer 108, the payment network 110, the issuer 112, and the consumer 116 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 114, or separate therefrom.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, transaction data, including abnormal/normal transaction data, traits of consumers and/or consumer purchase behaviors, trait reports, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 116; individuals associated with one or more of the merchants 102, 104, and 106, the acquirer 108, the payment network 110, the issuer 112, or engine 120 in the system 100; etc.) by, for example, displaying, audibilizing, and/or otherwise outputting information such as, but not limited to, information relating to the merchants 102, 104, and 106 (e.g., goods and/or services for sale, etc.), identifiers of abnormal transactions and/or atypical consumers, transaction data associated with the consumer 116 and/or the merchants 102, 104, and 106, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 114. In some exemplary embodiments, the computing device 200 includes the processor 202 and one or more network interfaces incorporated into or with the processor 202.

By way of example (and without limitation), the exemplary computing device 200 may include one or more servers, personal computers, laptops, tablets, PDAs, telephones (e.g., cellular phones, smartphones, other phones, etc.), point of sale (POS) terminals, combinations thereof, etc. as appropriate.

Referring again to FIG. 1, in general, the merchants 102, 104, and 106 offer one or various products for sale to the consumer 116. The consumer 116 presents payment to one of the merchants 102, 104, and 106 (e.g., to merchant 102 in the following description, etc.) for purchase of the product. The payment may be provided in the form of cash or a check, or it may be provided through a payment account, etc. When a payment account is used, the merchant 102, the acquirer 108, the payment network 110, and the issuer 112 cooperate, in response to the consumer 116, to complete a payment transaction for a product using the consumer's payment account. As part of the payment transaction, the consumer 116 initially provides information (e.g., a payment account number (PAN), etc.) about the payment account to the merchant 102 via a payment card, another payment device (e.g., a fob, a smartphone, etc.), or via login credentials for a previously established purchase account (e.g., an electronic wallet such as MasterPass™, Google Wallet, PayPass™, Softcard®, etc.), etc. The merchant 102 reads the payment account information and communicates, via the network 114, an authorization request to the payment network 110, via the acquirer 108 (associated with the merchant 102), to process the transaction (e.g., using the MasterCard® interchange, etc.). The authorization request includes various details of the transaction (e.g., transaction data, etc.) to help facilitate processing the authorization request. The payment network 110, in turn, communicates the authorization request to the issuer 112 (associated with the consumer's payment account). The issuer 112 then provides an authorization response (e.g., authorizing or declining the request) to the payment network 110, which is provided back through the acquirer 108 to the merchant 102. The transaction with the consumer 116 is then completed, or not, by the merchant 102, depending on the authorization response.

For the payment transaction, transaction data is generated as part of the interactions among the merchant 102, the acquirer 108, the payment network 110, the issuer 112, and the consumer 116. Depending on the transaction, the transaction data is transmitted from the merchant 102 to the issuer 112 through the payment network 110 or otherwise (e.g., as part of the authorization request, etc.). The transaction data may include, without limitation, the PAN for the consumer's payment account involved in the transaction, a payment amount for the products involved in the transaction, identifier(s) for the products involved in the transaction, description(s) of the products involved in the transaction, a listing of products involved in the transaction, a merchant name for the merchant 102 involved in the transaction, a merchant identification number (MID) for the merchant 102, a merchant category code (MCC) assigned to the merchant 102 (e.g., by the payment network 110 or by another payment network 110, based on a type of products and/or services provided by the merchant 102, etc.), a date and/or time of the transaction, a location of the transaction, etc.

Other payment transactions in the system 100, involving one or more of the consumer 116, the merchant 102, the other merchants 104 and 106, or other consumers and/or merchants accommodated by the system 100, but not shown, are also processed in similar manners to the above example transactions between the consumer 116 and the merchant 102. Transaction data is also generated in connection with these transactions.

Once generated, the transaction data is stored in one or more different components of the system 100. In the illustrated embodiment, for example, the payment network 110 collects the transaction data and stores it in memory 204 of the payment network computing device 200 (e.g., in a data structure associated with the memory 204, etc.). As such, the payment network 110 includes, in the memory 204 of the computing device 200, a compilation of consumers and merchants involved in the various transactions processed by the payment network 110, and the corresponding transaction data for the transactions. Further, the transaction data can be stored by the payment network 110, in the memory 204 of the computing device 200, in various different manners, for example, according to one or more of the payment account used by the consumer 116, the merchant(s) involved in the transactions (e.g., the MID for the merchant involved, the MCC for the merchant involved, etc.), or any other criteria, such that the transaction data is readily usable as described herein. It should be appreciated that the same or different transaction data may be collected and stored within other components of the system 100. In addition, while the transaction data is described as stored in the memory 204 of the payment network 110 computing device 200, it should be appreciated that the transaction data could be stored apart from the memory 204 (e.g., in data structures associated with the payment network 110 but apart from the computing device 200, etc.) in various implementations.

Further, when transactions are completed with payment accounts associated with payment networks other than payment network 110, or by payments other than through payment accounts (e.g., cash, checks, etc.), transaction data for the non-payment account transactions may also be collected and stored at one or more components of system 100. The transaction data acquired in this manner may be consistent with the transaction data described above, or may include less or more transaction data, potentially depending on the manner in which such transaction data is collected.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc. to use data collected during enrollment and/or collected in connection with processing the transactions, subsequently for one or more of the different purposes described herein (e.g., for use in identifying atypical consumers, etc.).

With continued reference to FIG. 1, the illustrated system 100 also includes an opportunity engine 120 associated with (e.g., implemented in, etc.) a computing device 200. The opportunity engine 120 is configured, often by computer-readable instructions, to, among other functions described herein, distinguish, among multiple transactions for at least one of the merchants 102, 104, and 106 (and potentially, other merchants), between normal and abnormal transactions, and store information for the abnormal transactions in a data set, in memory 204, for example. In so doing, the opportunity engine 120 detects abnormal transactions based on one or more parameters associated with the transactions. Such parameters may include, for example, transaction amounts, a time of day, a time of week, a time of year, and/or a product included in the transactions, or any other parameters associated with the transactions, etc. The parameters may further include parameters related to the consumer (broadly, traits) (e.g., age, gender, group affiliation, geographic location or residence, marital status, familial relationships, etc.), or the consumer's purchasing behaviors.

The opportunity engine 120 then identifies at least one trait consistent among at least a portion of the abnormal transactions in the stored data set. As described in more detail below, the trait or traits may be identified by a variety of statistical methods (e.g., clustering, correlation, look-alike modeling, regression analysis, etc.). The opportunity engine 120 then transmits a report to the particular ones of the merchants 102, 104, and 106 involved, which is indicative of the identified traits. The report is transmitted, in this exemplary embodiment, when the identified traits are dissimilar to traits of normal transactions by consumers at the involved merchants. Again, dissimilarities of the traits can be established using a variety of statistical methods.

It should be appreciated that further analysis may be performed based on the identified traits. In various embodiments, transaction data for consumers involved in the abnormal transactions may be considered. The opportunity engine 120 may, in these embodiments, identify one or more commonalties in transaction data from payment accounts associated with these consumers. The commonalties, e.g., purchase behaviors related to a particular subject matter, may provide insight into the abnormal transactions at the merchant 102. In one example, an online retailer may offer aluminum airline seat buckles for purchase. The buckles are decorated in pink-colored patterns intended for young women or adolescent girls, and thus constitute the vast majority of consumers of the merchant/online retailer. The opportunity engine 120, as described above, detects abnormal transactions (e.g., transactions involving consumers that are not young women or parents of young women), and identifies the following traits of the consumers associated with the abnormal transactions: age in the 20's, male, unmarried. By further analysis of the transaction data for these consumers, purchase transactions for outdoor equipment, including canoes and kayaks and related products, are identified as common to these consumers.

In this example embodiment, the opportunity engine 120 transmits the report to the particular ones of the merchants 102, 104, and 106 involved. It should be appreciated that other merchants may receive the report, from the opportunity engine 120. In certain embodiments, each merchant, whose data was used and/or accessed as the transaction data from which the abnormal transactions are detected, receive the report, from the opportunity engine 120. In other embodiments, transaction data from other merchants, who do not receive the report, may be employed. In at least one embodiment, the transaction data employed is limited to the transaction data from a single merchant, to which the opportunity engine transmits the report.

The report may include a variety of information regarding the one or more identified traits, including, for example, a description of the identified traits, comparisons between the identified traits and the traits of typical consumers, comparisons between normal and abnormal transactions, details about the abnormal transactions consistent with the identified traits (e.g., products purchased, etc.), projections of the market segments indicated by the traits, listings of consumers or groups of consumers (either prior consumers at the merchant or other merchants, or not) consistent with the one or more traits, listings of merchants that participate and/or are popular within the market segments indicated by the traits, etc.

It should be appreciated that a variety of information may be included in the report to the particular one(s) of the merchants 102, 104, and/or 106 involved (or other merchants), which may inform the merchants about the identified traits, the new market segments, and one or more ways to take advantage of and/or further identify the new market segments, etc. In the above airline buckle example, the report may indicate to the merchant/online retailer that the consumers are in their 20's, male and single (i.e., common traits), and also commonly purchase canoe and kayak related products. Based on the report, the merchant/online retailer is able to place advertisements for the airline buckles at canoe and kayak specialty websites. The merchant/online retailer may further research to discover that the consumers use the aluminum (i.e., rust-proof) buckles for boat outfitting. The merchant/online retailer may then alter the products, for those particular consumers (e.g., paint the buckles a different color, or not at all, etc.).

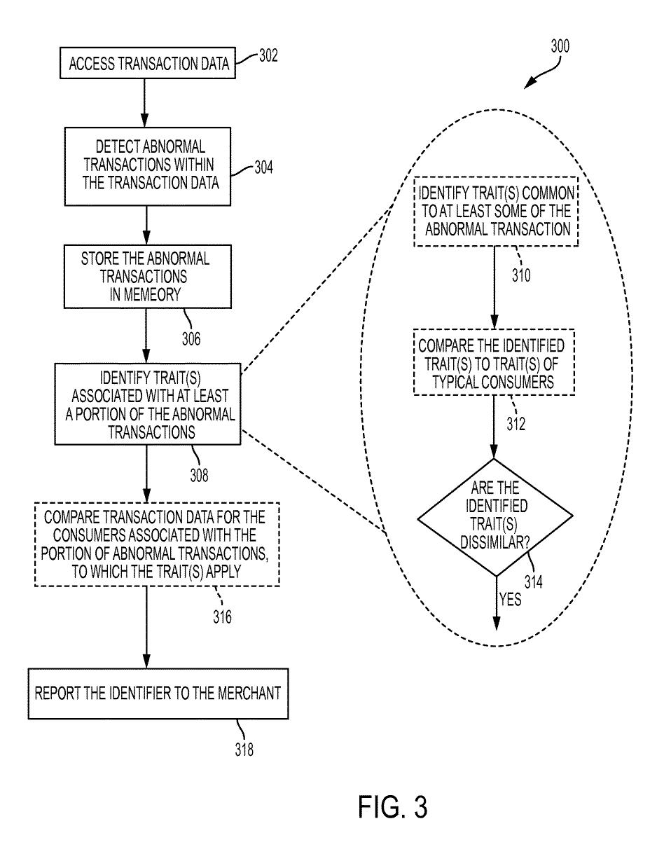

FIG. 3 illustrates exemplary method 300 for use in trending abnormal data. The exemplary method 300 is described as implemented in the opportunity engine 120 of the system 100, with further reference to the merchant 102, the acquirer 108, the payment network 110, the issuer 112, and the consumer 116. However, the method 300 could be implemented in one or more other entities, in other embodiments. Further, for purposes of illustration, the exemplary method 300 is described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the illustrated method 300, the opportunity engine 120 accesses transaction data, at 302. This includes accessing (and, in some implementations, retrieving) the transaction data, for the consumer 116, from the memory 204 of the computing device 200 of the payment network 110 and or issuer 112 (e.g., via network 114, etc.), for example, for all transactions by the consumer 116 over a predefined interval (e.g., the last month, the last three months, the last six months, the last year, the last two years, etc.), etc. In other embodiments, it should be appreciated that different transaction data may be accessed (e.g., all transaction data for a consumer 116, all transaction data for a payment account, all transaction data for a group of payment accounts, or consumers, etc.).

The accessed transaction data is associated with one or more of merchants 102, 104, and 106, and/or other merchants. The opportunity engine 120 may access transaction data for merchants, who expect to receive reports or other indicators of traits of atypical consumers, as described herein. Additionally, or alternatively, the transaction data may be associated with merchants, who do not expect, or who have not registered, to receive such reports or indicators of atypical consumers. In various embodiments, the transaction data may be associated with merchants who offer the same or similar products for sale. Additionally, or alternatively, the transaction data may be associated with merchants, for example, in the same geographic region (e.g., within the same ZIP code, city, county, country, etc.), of the same relative size (e.g., by sales volume, transaction count, ticket size, trade area, etc.), in the same lines of business (e.g., by MCC, etc.), of the same structure (e.g., online, brick-and-mortar, combinations thereof, etc.), combinations thereof, etc.

It should be appreciated that the form and/or content of the transaction data may vary, depending on, for example, the type of merchant, or the manner in which the transaction data was collected. The transaction data may include merchant identifiers or traits, consumer or traits, amounts of transactions, product identifiers/information, date/time of transactions, etc. In at least one embodiment, the transaction data indicates certain traits of the consumers involved in the corresponding transactions, including, for example, age, gender, geographic region, category or group affiliations, etc.

As shown in FIG. 3, the opportunity engine 120 detects abnormal transactions within the accessed transaction data, at 304. A transaction may be identified as abnormal based solely on aspects of the transaction, for example, an amount of the transaction, a time of day, week, or year of the transaction, and/or the product(s) included in the transaction, etc. For example, a gasoline purchase for $1150.00 may be abnormal, for a gas station where the average purchase is $73.00. Or the purchase of pool chemicals in winter in the Midwest may be abnormal. Additionally, or alternatively, one or more traits of the consumer, and/or the consumer's purchasing habits, may define a transaction as an abnormal transaction. Traits of the consumer may include, without limitation, age, gender, group affiliation (e.g., a taxidermy club member, etc., where membership in the club is identified/determined from transaction data associated with payment of club dues through the payment network 110, through social media, through other list services or third party venders, etc.), and/or geographic location or residence, etc. In the above example, a twenty-five year old male purchasing six pink-colored, patterned airline seat buckles would be an abnormal transaction. Or, where a motor cycle dealership has only one sale in a two year period to an 85 year old woman, the transaction is abnormal.

As suggested above, it should be appreciated that a variety of algorithms may be employed to identify/detect abnormal transactions, as compared to normal transactions. For example, abnormal transactions may be identified by clustering, regression, correlation, CHAID (i.e., chi-squared automatic interaction detection), indexing, other available statistical methods for identifying outliers, etc. Further, the abnormal transactions may be identified as part of a separate process (e.g., as part of other analyses of the normal transactions, for example), or separately as a particular analysis. In addition, the identification of abnormal transactions may be performed at regular or irregular intervals, depending on, for example, a volume of transactions to the merchants 102, 104, and 106, and/or other merchants, etc. It should be appreciated that thresholds for identifying abnormal transactions (and for distinguishing them from normal transactions) may depend on the statistical methods utilized. In some implementations, for example, abnormal transactions may be identified as outlying transactions falling outside an 80%, 85%, 90% or 95% confidence interval (i.e., representing the remaining percentage of transactions that exceed some calculated variance from a mean value), etc.

As an example, the opportunity engine 120 may calculate a Z-score to help identify outlier transaction sizes at a gas station. Then, upon analyzing transaction data associated with the gas station, if the opportunity engine 120 identifies a cluster of similar outlier amounts at the gas station for consumers that also make transactions at an RV park 100 miles away, the opportunity engine 120, in the steps below, may conclude that the gas station is a rest-stop for consumers traveling to the RV park. The opportunity engine 120 may then report this data to the gas station (as described more below), and the gas station may offer potable water and a dump station to attract more RV traffic, and their larger gas ticket sizes.

As another example, the opportunity engine 120 may identify abnormal purchases at a merchant via clustering. In this example, from transaction data accessed for the merchant, the opportunity engine 120 may identify that teenage, female buyers represent 85% of all purchases at the merchant (i.e., a first group of consumers), and that middle-age, male buyers represent 5% of all purchases at the merchant (i.e., a second group of consumers). The remaining 10% of purchases at the merchant are made by consumes having a wide mix of age and gender, that do not cluster into a well-defined group. Further, upon additional evaluation of transaction data for the second group of consumers, the opportunity engine 120 in last steps below, may further determine that all of the consumers also make purchases at outdoor stores and on travel to wilderness areas. The opportunity engine 120 may then report this data to the merchant (as described more below).

Once the abnormal transactions are detected at 304, the opportunity engine 120 stores the abnormal transactions (e.g., transaction data for the abnormal transactions, etc.) in a data set in memory, at 306, including, for example, in memory 204.

At 308, the opportunity engine 120 identifies one or more traits for at least a portion of the abnormal transactions. In particular, in this embodiment, as shown in the broken lines (i.e., optionally), the opportunity engine 120 identifies, at 310, one or more traits in the abnormal transactions for an interval, such as for example, 6 months, 1 year, 2 years, etc., to identify trends in the abnormal data. The opportunity engine 120 may employ any of a variety of techniques, alone or in combination, to identify trends in the abnormal transaction. These techniques may include, again for example, clustering, correlation, chi-squared automatic interaction detection (CHAID), regression, and/or indexing, etc. Again, it should be appreciated that thresholds for identifying traits (and for distinguishing them from other traits) may depend on the statistical methods utilized. In some implementations, for example, traits may be identified as outliers falling outside an 80%, 85%, 90% or 95% confidence interval (i.e., as traits representing the remaining percentages that exceed some calculated variance from a mean value), etc.

It should be appreciated that, in various embodiments, the opportunity engine 120 will restrict identification of the one or more traits until the sample size of abnormal transactions is sufficiently large to, for example, preserve the privacy of the consumers involved. For example, the opportunity engine 120 may only identify traits when the portion of abnormal transactions, upon which the traits are identified, exceeds a predetermined threshold.

When one or more traits are identified at 310, the opportunity engine 120 compares, at 312, the identified traits to traits of typical consumers of the particular merchants involved in the analysis. When one or more of the traits are dissimilar from the traits of the typical consumer, at 314, the opportunity engine 120 proceeds in the method 300. As discussed above, the traits may be identified as dissimilar based on, for example, clustering, correlation, look-alike modeling, regression analysis, etc. The opportunity engine 120 may proceed, in some embodiments, when only one trait is dissimilar from the traits of a typical consumer. In at least one embodiment, the opportunity engine 120 proceeds to transmit a report, as described below, even when each identified trait is similar to that of a typical consumer.

Optionally, as indicated by the broken lines in FIG. 3, the opportunity engine 120 compares, at 316, the transaction data for the consumers associated with the abnormal transactions, to which the identified traits apply. When commonalties among the consumers, and in particular among transactions to payment accounts associated with the consumers, for example, are discovered, the commonalties, or common traits, may offer insight into the reason for the abnormal transactions. In the airline buckle example above, the identification of canoe and kayak commonalties among the consumers provides insight into the unconventional use of the airline buckles as boat outfitting. It should be appreciated that a variety of different analyses may be performed, to further permit the traits identified herein to be used by the merchants to develop new market segments.

As shown in FIG. 3, upon identification of the one or more traits at 308, and/or following the comparison at 316, the opportunity engine 120 reports, at 318, the one or more traits to the particular merchants involved. The report may include only dissimilar traits, identified at 314, or may include all traits identified at 308. As described above, the report to the merchants may include a variety of different information, which may be employed by the merchants to investigate the abnormal transactions and/or develop new market segments. The opportunity engine 120 may report the data in various desired ways. For example, custom reports may be generated and delivered based on consulting engagements. Or, standard profiling reports (e.g., standard customer profiling reports, etc.) may be generated and made available, by the opportunity engine 120, via different interfaces accessible to merchants or others, etc.

The traits may be reported to all merchants 102, 104, and 106, and/or other merchants, to which transaction data access, at 302, was associated. Alternatively, the traits may be reported to only one or less than all the merchants, to which transaction data access, at 302, was associated. In at least one embodiment, merchants register, such that the opportunity engine 120 identifies the registered merchants as the merchants to which to report.

In some implementations, the method 300 may also include an operation of contacting a consumer associated with one of the detected abnormal transactions, whereby an inquiry may be presented to the consumer about the merchant involved in the transaction. This may be in the form of a survey, an offer, or otherwise.

In view of FIG. 3, in one example, a merchant specializes in the sale of taxidermy products, including, for example, taxidermy chemicals. One example chemical is “alum” or potassium aluminum sulfate. The taxidermy merchant's typical consumers are age 35 or older, and live in areas which are popular for hunting. In addition, the transaction volumes of the merchant typical fluctuate with hunting seasons in those areas, and the typical transaction amount is $100-250. The taxidermy merchant also has transactions in the amount of about $15-$25 to single males age 20-25 in summer months (e.g., distinct from hunting seasons). As described above, the opportunity engine 120 detects these transactions, as abnormal. While these transactions may go unnoticed by the merchant, the opportunity engine 120, with about 1 year of transaction data for the merchant, for example, detects over 40 transactions, which are abnormal. From the abnormal transactions, the opportunity engine 120 identifies that the consumers are commercial outfitters, located in Flagstaff, Arizona, Central Idaho, and Southern Oregon. These traits are passed to the taxidermy merchant, who, upon investigation of the potential new market segment, learns the commercial outfitters use the alum product to remove turbidity from silt laden river water before filtering the water. At which point, the taxidermy merchant may decide to market its alum product to commercial outfitters and other outdoor guides, thereby participating in a new market segment.

In this manner, by reporting the new traits to the merchant, the merchant is able to market to the new market segment, and/or investigate a relationship between the traits and the purchases at the merchant. It should be appreciated that the methods and systems herein seek to enhance the information gained through historical transaction data, including the transaction data previously discarded as noise or outlier data.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data for at least one merchant, the transaction data including multiple transactions, (b) detecting abnormal transactions from the multiple transactions based on at least one parameter of the transactions, (c) identifying at least one trait associated with at least a portion of the abnormal transactions, but not associated with a typical consumer associated with the at least one merchant, (d) reporting the at least one trait to the at least one merchant.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in trending abnormal data, the method comprising:
accessing transaction data for at least one merchant, the transaction data including multiple transactions;
detecting abnormal transactions from the multiple transactions based on at least one parameter of the multiple transactions;
identifying, at a computing device, at least one trait associated with at least a portion of the abnormal transactions, but not associated with a typical consumer of the at least one merchant; and
reporting the at least one identified trait to the at least one merchant.

2. The computer-implemented method of claim 1, wherein identifying the at least one trait includes:
identifying at least one common trait among at least a portion of the abnormal transactions; and
comparing the at least one common trait to one or more traits of a typical consumer of the at least one merchant;
wherein the at least one identified trait includes the at least one common trait, when the at least one common trait is dissimilar to one or more traits of a typical consumer of the at least one merchant.

3. The computer-implemented method of claim 2, wherein the at least one identified trait includes at least one of an age and a gender of consumers of the portion of the multiple abnormal transactions.

4. The computer-implemented method of claim 1, wherein the at least one parameter includes transaction amounts of the abnormal transactions, as compared to transaction amounts of typical transactions.

5. The computer-implemented method of claim 1, wherein identifying the at least one trait includes identifying the at least one trait based on a product identifier included in the portion of the abnormal transactions.

6. The computer-implemented method of claim 1, wherein the at least one trait includes at least one of a group affiliation of consumers of the portion of the abnormal transactions and a geographic location of consumers of the portion of the abnormal transactions.

7. The computer-implemented method of claim 1, further comprising identifying a purchase behavior associated with the consumer based on transaction data associated with a payment account of said consumer; and
wherein the at least one trait includes a purchase behavior of the consumer.

8. The computer-implemented method of claim 1, further comprising accessing transaction data for at least one secondary merchant; and
wherein detecting the abnormal transactions includes detecting said abnormal transactions in the transaction data for the at least one merchant and the at least one secondary merchant.

9. The computer-implemented method of claim 1, wherein the at least one merchant includes multiple merchants, each of the multiple merchants associated with at least one common merchant category code.

10. The computer-implemented method of claim 1, further comprising contacting at least one consumer associated with the portion of the multiple abnormal transactions, whereby an inquiry may be presented about the at least one merchant.

11. The computer-implemented method of claim 1, further comprising detecting the abnormal transactions includes detecting the abnormal transactions from the multiple transactions further based on a second parameter of the transactions, the second parameter being different than the at least one parameter.

12. A system for use in identifying new market segments for at least on merchant, based on transaction data for payment accounts, the system comprising:
a memory including transaction data for multiple merchants, the transaction data including, for each of the merchants, multiple transactions to payment accounts associated with consumers; and
at least one processor coupled to the memory and configured to:
distinguish, among multiple transactions for the at least one merchant, between normal transactions and abnormal transactions;
identify at least one trait consistent among at least a portion of the abnormal transactions; and
transmit, to the at least one merchant, a report indicative of the at least one identified trait, when the identified at least one trait is dissimilar to one or more traits of consumers of normal transactions to the at least one merchant.

13. The system of claim 12, wherein the processor is configured to distinguish the abnormal transactions and normal transactions based on one or more of look-alike modeling, clustering, and regression analysis.

14. The system of claim 12, wherein the processor is further configured to distinguish, among multiple transactions for secondary merchants, between normal transactions and abnormal transactions; and
wherein the processor is further configured to transmit the report when the identified at least one trait is dissimilar to one or more traits of consumers of normal transactions to the secondary merchants.

15. The system of claim 12, wherein the at least one parameter includes a transaction amount, a time of day, a time of week, a time of year, and/or a product included in the transaction.

16. The system of claim 12, wherein the processor is configured to access transaction data including the multiple transactions, based on at least a merchant category code associated with the at least one merchant.

17. The system of claim 12, wherein the identified at least one trait, indicated in the report, includes an age, a gender, and/or a geographical region of consumers of the abnormal transactions.

18. A non-transitory computer readable storage media including executable instructions which, when executed by at least one processor, cause the at least one processor to:
access transaction data associated with a merchant, the transaction data including multiple abnormal transactions;
identify at least one trait associated with at least a portion of the abnormal transactions, but not associated with a typical consumer associated with the merchant;
for consumers of the portion of abnormal transaction, identify one or more commonalties in transaction data from payment accounts associated with said consumers; and
report at least the identified at least one trait and the one or more commonalties to the merchant.

19. The computer readable storage media of claim 18, wherein the computer executable instructions, when executed by the at least one processor, further cause the at least one processor to identify the at least one trait associated with at least a portion of the abnormal transactions, when the portion of the abnormal transactions exceeds a predetermined threshold.

20. The computer readable storage media of claim 18, wherein the at least one trait includes one or more of an age, a gender, a group affiliation, and a geographic location of consumers of the abnormal transactions.
